(19) United States
(12) Patent Application Publication
(10) Pub. No.: US 2008/0064809 A1
(43) Pub. Date: Mar. 13, 2008

(54) Impregnating Resin Formulation

(76) Inventors: Sascha Todter-Konig, Hamburg (DE); Gunter Hegemann, Hamburg (DE); Mark Abendroth, Hamburg (DE); Klaus-W. Lienert, Hamburg (DE)

Correspondence Address: FRIEDRICH KUEFFNER, 317 MADISON AVENUE, SUITE 910, NEW YORK, NY, 10017, US

(21) Appl. No.: 11/629,155

(22) PCT Filed: Jun. 8, 2005
(86) PCT No.: PCT/EP05/52703

§ 371 Date: Mar. 26, 2007

(30) Foreign Application Priority Data
Jun. 11, 2004 (DE) 10 2004 028 417.2

(51) Int. Cl. C08L 55/00; C08L 33/04

(52) U.S. Cl. 524/518; 525/222

(57) ABSTRACT

The invention relates to an impregnating resin formulation containing a component A which contains an unsaturated polyester resin comprising allyethers, a component B which contains dicyclopentadiene terminated, unsaturated polyester resin which is different from the component A, a component C which contains an additional unsaturated polymer which is different from polyester resins of components A and B, and, optionally, hardeners, accelerators, stabilizers, additives and rheology additives. Said invention also relates to the use thereof in order to impregnate windings for the production of base materials of flat isolating material and in order to cover printed circuit boards.

This application claims the priority of DE 10 2004 028 417.2-43.

The present invention relates to an impregnating resin formulation for electrical machinery.

The impregnating of electrical windings is a standard operation in the production of electrical machinery. The cured impregnating resin has the function of mechanically fixing the winding, protecting it against aggressive chemicals and environmental influences, removing the heat formed, and providing electrical insulation.

State of the art is the use of unsaturated polyesters containing styrene. These polyesters are general knowledge, and their preparation and use are familiar to the skilled worker. References can be found in the standard works of polymer chemistry and in the suppliers' brochures. Additionally there are conference reports on conventionally processable systems (e.g., Varnish and resin usage with various motor construction, M. Winkeler, IEEE Proceedings, 1999, p. 143; Evaluation of electrical insulating resins for inverter duty application, M. Winkeler, IEEE Proceedings 1997, p. 145), and also on, for example, cold-curing systems (Heatless cure coating of electrical windings, Th. J. Weiss, IEEE Proceedings, 1993, p. 443).

Since resins containing styrene emit styrene on curing, it is necessary to treat the exhaust air from the processing lines. If comonomers other than styrene are used instead, such as vinyltoluene and various acrylates, there is in principle nothing different about the emissions. The approach has therefore been to develop comonomer-free unsaturated polyester resins suitable for use for impregnating electrical windings.

EP 0 968 501 describes liquid formulations which can be cured without comonomer and comprise unsaturated polyesters, and which are also UV-curable. The unsaturated polyester contains dicyclopentadiene structures and maleic acid structures. These formulations, however, have a relatively high viscosity (higher than 2600 mPas). This is a barrier to processing on customary lines.

EP 1 122 282 describes formulations which are likewise curable without comonomer and comprise unsaturated polyester resins. They are composed of unsaturated polyesters based on maleic acid and dicyclopentadiene and polymeric crosslinkers, in which, for example, isoprenol (3-methyl-3-buten-1-ol) is used as a constituent unit. The viscosities of the resin mixtures are in some cases very high. Moreover, the formulations have the disadvantage that resins and polymeric crosslinkers cannot be mixed arbitrarily, since the polymeric crosslinker per se is not curable.

The problem addressed by the present invention was that of developing a low-viscosity formulation comprising a comonomer-free unsaturated polyester resin, said formulation being free from solely noncuring polymeric crosslinkers and being suitable for impregnating electrical windings.

This problem is solved by a low-viscosity impregnating resin formulation comprising

a component A comprising an unsaturated polyester resin containing allyl ether,

a component B comprising a dicyclopentadiene-terminated unsaturated polyester resin other than component A,

a component C comprising a further unsaturated polymer other than the polyester resins of components A and B, and also, if desired, hardeners, accelerators, stabilizers, additives, and rheoadditives.

The impregnating resin formulation may preferably be composed of components A, B, C, and also the typical hardeners, accelerators, stabilizers, and additives, rheoadditives (rheological additives).

Low-viscosity impregnating resin formulations in the context of the present invention preferably have a viscosity of less than or equal to 1500 mPas, measured at 25° C.

Particularly preferred impregnating resin formulations have a viscosity between 600 (inclusive) and 1300 (inclusive) mPas, with particular preference between 850 (inclusive) and 1200 (inclusive) mPas, measured at 25° C.

The unsaturated polyester resins containing allyl ether that are present in component A preferably comprise an unsaturated polyester resin or a mixture of unsaturated polyester resins, synthesized from trimethylolpropane monoallyl ether and/or trimethylolpropane diallyl ether, glycols, maleic acid, and other components known from unsaturated polyester resin chemistry. The polyester resins thus synthesized may in accordance with the invention be modified with imide structures, dicyclopentadiene structures, with isocyanates and/or melamine resins.

These resins are known (see, for example, brochure No. 0207 from Perstorp, DE 2645657, DOS 2113998) and can be prepared by reacting allyl ethers, polyols, carboxylic acids, and also monofunctional molecules as chain terminators.

The preparation of these resins is likewise general knowledge. It involves heating the components, with or without esterification catalyst, typically at temperatures between 160 and 200° C. The reaction is typically carried out under inert gas. In order to facilitate removal of the water formed it is possible to use an azeotrope and/or vacuum. The course of the condensation is typically monitored by determining the acid number and/or the condensation viscosity.

Allyl ethers which can be used include trimethylolpropane monoallyl, trimethylolpropane diallyl, and penta-erythritol triallyl ether. Preference is given to all three, alone or in various blends.

As polyols are ethylene glycol, di- and triethylene glycol, neopentyl glycol, 1,3- and 1,6-hexanediol, per-hydrobisphenol A, glycerol, trimethylolpropane, tris-(2-hydroxyethyl) isocyanurate, pentaerythritol, and dipentaerythritol. Preference is given to di- and triethylene glycol, neopentyl glycol, and trimethylolpropane.

As carboxylic acids use is made of alpha, beta-unsaturated dicarboxylic acids or derivatives thereof such as maleic anhydride and fumaric acid and their blends with modifying dicarboxylic acids such as adipic acid, succinic acid, phthalic anhydride, isophthalic acid, terephthalic acid, and 2,6-naphthalenedicarboxylic acid. Preference is given to maleic anhydride and adipic acid.

Chain terminators used are monofunctional carboxylic acids and/or monofunctional alcohols, examples being tall oil fatty acid, benzoic acid, 2-ethylhexanoic acid, hexanol, 2-ethylhexanol, benzyl alcohol, tert-butanol, isoprenol (3-methyl-3-buten-1-ol), and the reaction product of tetrahydrophthalic anhydride with ethanolamine. Preference is given to hexanol, isoprenol, and the reaction product of tetrahydrophthalic anhydride with ethanolamine.

In accordance with the invention component B may be composed of at least one binder other than component A and described in EP 0 968 501 and/or EP 1 122 282.

The unsaturated polyester resin other than component A that is present in component B and contains dicyclopentadiene structures may be prepared, for example, by the addition reaction of maleic acid and dicyclopentadiene, glycols, maleic acid, and other components known from unsaturated polyester resin chemistry.

In accordance with the invention component C may comprise a commercially customary unsaturated polymer. These polymers are available commercially under trade names such as Laromer PO 33F, Sartomer SR 9045 or Sartomer CD 9021, or polyethylene glycol divinyl ether.

The unsaturated polymer present in component C may be prepared by functionalizing existing polymers with molecules containing double bonds, such as, for example, the reaction product of a carboxyl-terminated polyacrylate with glycidyl methacrylate, or of a poly-ether polyol with an unsaturated isocyanate. Additionally it is possible to employ polymeric vinyl ethers, such as polyethylene glycol divinyl ethers of different molecular weight, for example.

The impregnating resin formulation of the invention may contain
1. 40%-95% by weight of unsaturated polyester resin containing allyl ether (component A), preferably 50.0%-90% by weight, with particular preference 60%-80% by weight,
2. 5.0%-60% by weight of dicyclopentadiene-terminated unsaturated polyester resin (component B), preferably 8.0%-40% by weight, with particular preference 10%-30% by weight,
3. 1.0%-30% by weight of unsaturated polymer (component C), preferably 1.0%-20% by weight, more preferably 1.0%-10% by weight,
4. 0.1%-5% by weight of hardeners, accelerators, stabilizers, additives, and rheoadditives, preferably 0.5%-4% by weight, with particular preference 1%-3% by weight,
   the percentages being based in each case on the complete impregnating resin formulation.

With preference the formulation of the invention may be composed of these components.

In accordance with the invention the three components A, B, and C are preferably first mixed and formulated with the typical hardeners, accelerators, stabilizers, and additives. This gives formulations which, depending on the composition, low viscosity, a good cure behavior and cured homogeneous molding materials having outstanding mechanical, electrical, and thermal properties.

The impregnating resin formulation of the invention is accordingly prepared preferably by blending components A, B, and C, whereas the additions of hardeners, accelerators, stabilizers, additives, and rheoadditives are added preferably at the end.

Hardeners which have proven appropriate include peroxides, such as dicumyl peroxide and tert-butyl perbenzoate, and also silylated benzpinacols. Through the use of photoinitiators, such as phosphine oxides and ketals, for example, it is possible to produce a UV-photocuring formulation.

Accelerators are metal soaps, such as cobalt, vanadium, and zirconium octoates or naphthenates.

Stabilizers used are alkylated phenols, hydroquinones, and benzoquinones, such as 2,4-di-tert-butylphenol or methylhydroquinone. Additives are the flow control and surface additives known to the skilled worker.

Rheological additions which have been found appropriate include pyrogenic silicas, Bentones, and polymeric ureas. Reference may be made here to the coatings handbooks.

At room temperature the impregnating resin formulation of the invention is liquid, of low viscosity, and comonomer-free. It can be processed on the conventional processing lines, by means for example of dipping, trickling, dip-rolling, casting, and by vacuum impregnation and vacuum-pressure impregnation of electrical windings.

The described processing of the impregnating resin formulation is followed by curing. The cure in question may comprise thermal curing. This can be achieved either in an oven or by the Joule heat of the winding, or through the combination of these possibilities.

Curing may also be achieved by means of radiation, preferably by means of UV radiation. Particularly if the impregnating resin formulation has been provided with a photoinitiator, it can be cured on the laminated core using UV light. Also possible in accordance with the invention is the combination of thermal curing and UV light curing, particularly when curing is envisaged directly on the laminated core. This also allows the simultaneous utilization of Joule heat and UV light for the cure.

In addition to the impregnation of electrical windings it is also possible to use the impregnating resin formulation of the invention to coat flat modules in electronics, hybrids, SMD modules, and assembled printed circuit boards, or as a base material for sheetlike insulating materials.

The invention is described in more detail below with reference to examples. Testing takes place in accordance with DIN and IEC standards.

### 1 EXAMPLES

### Example 1

### Preparation of an Allyl Ether-Modified Unsaturated Polyester Resin 1

In a standard three-neck flask apparatus 290 g of maleic anhydride, 114 g of triethylene glycol, 320 g of 2-ethylhexanol, 190 of trimethylolpropane diallyl ether, and 70 g of glycerol are reacted with one another at 190° C. under inert gas. The acid number of the resulting resin is 20 mg KOH/g and the viscosity is 20 Pas.

### Example 2

### Preparation of an Allyl Ether-Modified Unsaturated Polyester Resin 2

First in a standard three-neck flask apparatus 302-g of maleic anhydride, 28 g of water, and 217 g of dicyclopentadiene are reacted. Then, in the same way as in Example 1, the preliminary product is reacted with 161 g of neopentyl glycol, 134 of trimethylolpropane monoallyl ether, and 157 g of hexanol at 195° C. The resulting resin has an acid number of 21 mg KOH/g and a viscosity of 22 Pas.

### Example 3

### Preparation of an Allyl Ether-Modified Unsaturated Polyester Resin 3

First in a standard three-neck flask apparatus 271 g of maleic anhydride, 17 g of water, and 130 g of dicyclopentadiene are reacted. Then, in the same way as in Example 1, the preliminary product is reacted with 208 g of triethylene glycol, 48 g of neopentyl glycol, 120 g of 2-ethylhexanol, and 197 of trimethylolpropane diallyl ether at 190° C. The resulting resin has an acid number of 24 mg KOH/g and a viscosity of 12 Pas.

### Example 4

### Preparation of a Dicyclopentadiene-Modified Unsaturated Polyester (Component B)

The product from Example 1 of EP 1 122 282 was prepared.

### Example 5

### Preparation of an Impregnating Resin Formulation with Resin 1

100 g of resin from Example 4, 790 g of resin from Example 1, 80 g of Laromer PO 33F, 1 g of cobalt octoate, 8.5 g of a commercially customary pyrogenic silica, 0.5 g of di-tert-butylphenol, and 20 g of tert-butyl perbenzoate are mixed thoroughly. The formulation has a viscosity of 1050 mPas, a gel time of 3 minutes at 120° C. The formulation is used to impregnate drilled rods in accordance with IEC 61033 (method A) and, after curing (1 hour at 160° C.), the baking resistance is measured. At 155° C. it is 50 N. Additionally the formulation is used to immerse a stator, size 90, which is cured at 150° C. for 1 hour. The dripping loss during oven curing was extraordinarily low. Thereafter the stator is sawn open, and resin uptake and impregnation quality are inspected. The stator was excellently impregnated and the winding fully saturated with resin.

### Example 6

### Preparation of an Impregnating Resin Formulation with the Resin from Example 2

100 g of resin from Example 4, 800 g of resin from Example 2, 70 g of Laromer PO 33F, 1 g of cobalt octoate, 0.5 g 0.5 g of di-tert-butylphenol, and 20 g of tert-butyl perbenzoate are mixed. The formulation has a viscosity of 1000 mPas, a gel time of 4 minutes at 120° C. The formulation is used to impregnate drilled rods in accordance with IEC 61033 (method A) and, after curing (1 hour at 160° C.), the baking resistance is measured. At 155° C. it is 65 N. Additionally the formulation is used to immerse a stator, size 90, which is cured at 150° C. for 1 hour. Thereafter the stator is sawn open, and resin uptake and impregnation quality are inspected. The stator was excellently impregnated.

### Example 7

### Preparation of an Impregnating Resin Formulation with Resin 3

100 g of resin from Example 4, 800 g of resin from Example 3, 70 g of Laromer PO 33F, 1 g of cobalt octoate, 0.5 g of di-tert-butylphenol, and 20 g of tert-butyl perbenzoate are mixed. The formulation has a viscosity of 1200 mPas, a gel time of 3 minutes at 120° C. The formulation is used to impregnate drilled rods in accordance with IEC 61033 (method A) and, after curing (1 hour at 160° C.), the baking resistance is measured. At 155° C. it is 51 N. Additionally the formulation is used to immerse a stator, size 90, which is cured at 150° C. for 1 hour. Thereafter the stator is sawn open, and resin uptake and impregnation quality are inspected. The stator was excellently impregnated.

### Comparative Example 8

### Impregnation of the Resin from Example 4

The resin from Example 4 is activated with 2% of dicumyl peroxide. The viscosity is 8 Pas. A size-90 stator is immersed therein and cured at 160° C. for 1 hour. Thereafter the stator is sawn open, and resin uptake and impregnation quality are inspected. The resin uptake is much less than that in Examples 5 to 7.

### Comparative Example 9

### Impregnation of the Resin from Example 1

The resin from Example 1 is activated with 3% of tert-butyl perbenzoate. The viscosity is 20 Pas. A size-90 stator is immersed therein and cured at 160° C. for 1 hour. Thereafter the stator is sawn open, and resin uptake and impregnation quality are inspected. The resin uptake is much less than that in Examples 5 to 7.

### Comparative Example 10

### Impregnation with the Unsaturated Polymer

Laromer PO 33F is activated at 2% of tert-butyl perbenzoate and a stator of size 90 is impregnated therewith and cured at 130° C. for 1 hour. Thereafter the stator is sawn open, and resin uptake and impregnation quality are inspected. The resin flakes off from the winding heads and ruptures in the winding.

1. A low-viscosity impregnating resin formulation comprising
a component A comprising an unsaturated polyester resin containing allyl ether,
a component B comprising a dicyclopentadiene-terminated unsaturated polyester resin other than component B,
a component C comprising a further unsaturated polymer other than the polyester resins of components A and B,
and also, if desired, hardeners, accelerators, stabilizers, additives, and rheoadditives.

2. The impregnating resin formulation of claim 1, wherein component A comprises 40%-95% by weight of unsaturated polyester resin containing allyl ether, preferably 50.0%-90% by weight, with particular preference 60%-80% by weight,
component B comprises 5.0%-60% of dicyclopentadiene-terminated unsaturated polyester resin, preferably 8.0%-40%, with particular preference 10%-30%, and
component C comprises 1.0%-30% of unsaturated polymer, preferably 1.0%-20%, with particular preference 1.0%-10%,
the percentages being based in each case on the complete impregnating resin formulation.

3. The impregnating resin formulations of claim 1, wherein they have a viscosity of less than or equal to 1500 mPas, preferably between 600 (inclusive) and 1300 (inclusive) mPas, and with particular preference between 850 (inclusive) and 1200 (inclusive) mPas, in each case measured at 25° C.

4. The impregnating resin formulation of claim 1, wherein unsaturated polyester resin in component A comprises trimethylolpropane monoallyl ether and/or trimethylolpropane diallyl ether and/or pentaerythritol triallyl ether, and also glycols, polyols, and carboxylic acids.

5. The impregnating resin formulation of claim 1, wherein the unsaturated polyester resin in component B comprises dicyclopentadiene structures, preparable by the addition reaction of maleic acid and dicyclopentadiene, and also glycols, carboxylic acids, and other components known from unsaturated polyester resin chemistry.

6. The impregnating resin formulation of claim 1, wherein the unsaturated polymer in component C is preparable by the functionalization of existing polymers with molecules containing double bonds.

7. The impregnating resin formulation of claim 1, wherein components A, B, and C are curable through the addition of free-radical initiators to thermoset molding materials.

8. The use of the impregnating resin formulation of claim 1 for impregnating electrical windings.

9. The use as claimed in claim 8 for impregnating electrical windings by dipping, trickling, dip-rolling, casting, vacuum impregnation and/or vacuum-pressure impregnation, followed by thermal curing.

10. The use as claimed in claim 8 for impregnating electrical windings by dipping, trickling, dip-rolling, casting, vacuum impregnation and/or vacuum-pressure impregnation, followed by UV curing in combination with thermocuring.

11. The use of the impregnating resin formulation of claim 1 for producing base materials of sheet insulating materials.

12. The use of the impregnating resin formulation of claim 1 for coating flat modules in electronics, hybrids, SMD modules, and assembled printed circuit boards.
